(19) United States
(12) Patent Application Publication
(10) Pub. No.: US 2011/0297287 A1
(43) Pub. Date: Dec. 8, 2011

(54) APPLIED TO BAND FOR PROTECTION OF VEHICULAR WHEELS AND TIRES

(76) Inventor: Alexandre S. Vianna, Florianopolis (BR)

(21) Appl. No.: 12/794,394

(22) Filed: Jun. 4, 2010

(51) Int. Cl. B60C 17/04

(52) U.S. Cl. 152/520

(57) ABSTRACT

A system that lies inside a tire allowing a vehicle to be driven normally in emergency situations, even with a flat tire. The system comprises two semicircular rubber segments with a trapezoidal profile with bottoms having two blunt planes at different angles. The segments also have a plurality of transverse oval holes formed therein. Ends of the segments are united by an assembly including a ratchet that draws in steel cables or high-strength strap to unite the ends. The steel cables or high-strength strap are inserted inside the segments. Each ratchet has a half provided with one holed main axle, having a longitudinal slot that receives the steel cables or strap, which has one of its ends linked to another half of another ratchet. Counterweights may also be inserted inside the rubber segments to improve the system balance.

### FIELD OF THE INVENTION

This invention relates to improvements introduced in the Brazilian Patent of Invention (PI) [Intellectual Property] no. 0301446-0 filed on Apr. 4, 2003 for the same Applicant.

### BACKGROUND

It is well-known that a substantial quantity of vehicles nowadays are factory equipped with, adapted later on, with wheels made with materials known as “light alloys,” that is, metal alloys such as e.g., titanium, magnesium and aluminum.

Tire structuring systems that use materials of high surface toughness and/or mechanical high-strength, such as steel, carbon fiber, engineering plastic (i.e., nylon, Teflon, etc.) and others, involve high risk of fracture of the “light alloy” base metal wheels; this may occur after impacts originated from the precarious conditions of our roads, which is quite common unfortunately.

The state of the art at the time of PI no. 0301446-0 filed on Apr. 4, 2003 shows the following examples:

(a) Steel band: the product attaches only the tire lateral strap to the wheel hub, only preventing that the same does not dissemble from the wheel when the tire is without pressure. This therefore, does not aggregate any additional structuring to the tire. In such condition, it is impossible to steer an empty-tire vehicle and much less driving a no tire vehicle.

(b) Carbon fiber band or engineering plastic: when the tire losses pressure, this equipment will withstand its weight in order for the vehicle to maintain satisfactory driving conditions. However, it is indispensable the tire frame as a device of adherence rendering limited its efficiency, because without such tire frame (loss of tire), this product losses its efficiency due to its lack of adherence to the pavement. As it has been already said previously, this product, made up from a high toughness material, represents a high risk to break the wheel in case of a strong impact.

(c) Seal gel: because it is a gel, this product presents a limited performance just to small holes, it does not aggregate any additional frame to the tire; making it impossible to steer an empty-tire vehicle, much less to drive a no tire vehicle. Furthermore, considering it is a body in constant movement, it severely affects the balance of the wheel and tire assembly. Oxidation of steel wheels is also possible.

After analyzing these problems, the Applicant developed the technology in PI no. 301446-0, which comprised a rubber band attached around the wheel, under the tire, forming a sub-tire. The “sub-tire” had a smaller diameter than the tire, but had a larger diameter than the wheel.

Structural steel reinforcements ensured system stability. Such reinforcements were made up of a curved steel plates, inserted inside the rubber, forming a steel band, the ends of which were united by steel cables. This frame is responsible for attaching the system upon wheel.

The protection band is made up of elastomer having similar characteristics as the ones used in industrial tire manufacturing. Their reinforcements are put forward in steel having high carbon content (type Improved Plow steel), galvanized in accordance with the ASTM International Standard, that have rendered the mechanical strength necessary against impacts and stresses raised out from torque transfer and from forces of rolling friction and “cornering” deriving from natural dynamics of a conventional passenger vehicle in movement.

However, after several tests, it has been proved that the steel band provided an excessive rigidity to the system. Such excessive rigidity made it difficult to mold the system upon a wheel. This has made it difficult to install it on a wheel and has impaired the locking efficiency.

Thus, it is desired to have a more flexible steel frame in order to solve these problems.

### SUMMARY

The disclosed embodiments provide a system that lies inside a tire allowing a vehicle to be driven normally in emergency situations, even with a flat tire. The system comprises two semicircular rubber segments with a trapezoidal profile with bottoms having two blunt planes at different angles. The segments also have a plurality of transverse oval holes formed therein. Ends of the segments are united by an assembly including a ratchet that draws in steel cables or high-strength strap to unite the ends. The steel cables or high-strength strap are inserted inside the segments. Each ratchet has a half provided with one holed main axle, having a longitudinal slot that receives the steel cables or strap, which has one of its ends linked to another half of another ratchet. Counterweights may also be inserted inside the rubber segments to improve the system balance.

According to one aspect, an assembly for use within a tire is provided. The assembly comprises two semicircular rubber segments, each having two ends, each segment having a steel cable or strap formed therein, one end of each segment comprising a ratchet for drawing-in the steel cable or strap to pull the ends of the segments together.

### BRIEF DESCRIPTION OF THE DRAWINGS

Embodiments of the invention will now be described in greater detail with reference to the drawings.

FIGS. 1, 2, 3 and 4 illustrate details of the traction ratchet and steel cable or high-strength strap comprising the flexible frame.

FIGS. 5 and 6 show an elevation and profile of the entire system.

FIGS. 7 and 8 illustrate details of FIG. 6, showing the profile of the blunt planes and the system steel cable/traction strap.

### DETAILED DESCRIPTION

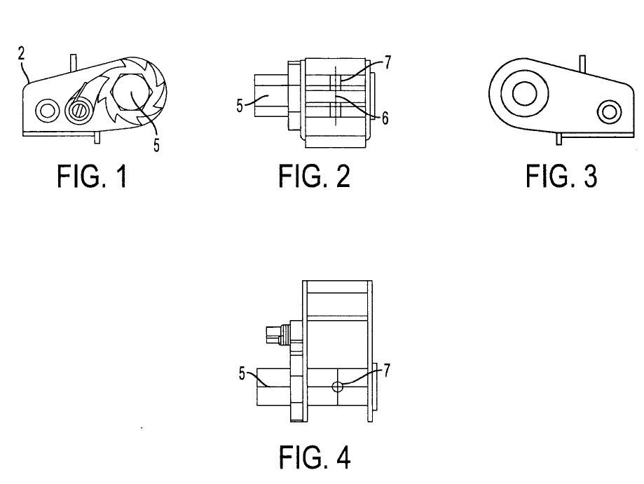

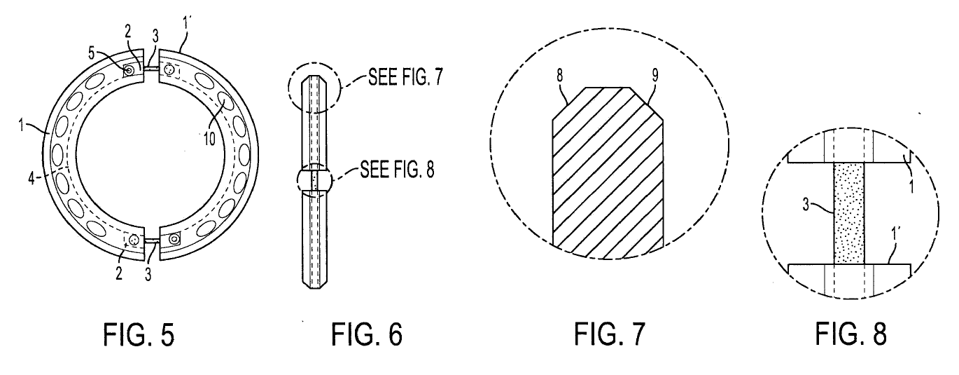

Referring to FIGS. 1-8, the disclosed improvements include two semicircular rubber segments 1 and 1′, in half moon shape. The ends of the segments 1 and 1′ are united by an assembly comprising a ratchet 2 that draws steel cables or a high-strength strap 3 to force the ends of bands 1 and 1′ towards each other. These steel cables or high-strength strap 3 are inserted inside band segments 1, 1′ (shown by dashed line 4), uniting parts of the ratchet 2 in each segment 1 and 1′.

Each ratchet 2 has a half provided with a holed main axle 5, having a longitudinal slot 6, which receives the steel cables or high-strength strap 3. The steel cables or high-strength strap 3 has one of its ends linked to another half of each ratchet 2. Axle 5 is trespassed by a transverse threaded hole 7 to fix a screw (not shown), which locks the steel cable or the strap. It should be appreciated that each end of the segments 1, 1′ can have its own ratchet 2. Alternatively, one end of each segment 1, 1′ can have a ratchet 2 that draws in a cable or strap 3 exiting a different end of the other strap 1, 1′.

Each segment 1-1′ has bottoms made up by two blunt planes 8 and 9 with different angles (FIG. 7). It can be seen that each segment 1, 1′ has a plurality of transverse oval holes 10 in order to alleviate its weight. It is worthwhile to note that counterweights may be inserted into the rubber segments to improve system balance.

The disclosed embodiment provides many improvements over existing tire systems. The first improvement is its flexible frame. The prior system was made up of a rubber band with a rigid steel plate strap inserted inside it, with their ends attached by steel cables. That steel band was responsible for the attachment of the rubber band to the wheel.

The disclosed embodiment substitutes the rigid frame of the steel plate with a flexible frame, also inserted inside the rubber. The frame can utilize a steel cable or high-strength strap. The attachment of the system is now done by this flexible frame using a ratchet at one of its end. This ratchet provides the retracting of the other flexible frame end, tightening the rubber band against the wheel providing the system attachment.

This situation provides a much more malleability to system allowing it to be attached much to the wheel better. This makes assembly easier assembling and improves its locking at wheel. In addition, the disclosed system provides highly successful drivability when the tire is without pressure because the system keeps the tire framed in its place; also keeping its drivability even without a tire.

Moreover, there is no risk of causing a possible break in the wheel because the frames characteristic resilience almost entirely absorbs the energy that is generated by impacts, transferring a very small part of the impact energy to the center of the wheel hub (its weakest part). In addition, the flexible frame does not cause oxidation of steel wheels. Further, the system is always easy to install and it can be assembled and disassembled in any conventional garage.

The second improvement of the disclosed system is the ratchet. The substitution of the rigid steel plate frame with the disclosed flexible steel cable/high-strength strap frame has made the development of the retracting system more appropriate.

Two ratchets have been developed with different retracting systems. In the disclosed embodiment, such ratchets are fixed in one end of the flexible frame, inserted inside the rubber band. Another end of the flexible frame is aimed to retract the ratchet. One ratchet has been developed only for steel cables. A second ratchet allows retracting of both steel cables and a high-strength strap.

The unique ratchet for use with steel cables has a flat retracting axle, with a fishing system where the steel cable is anchored for its retracting, which is useful only in case of using cables.

The ratchet for use with steel cables and the straps has a slot inside the retracting main axle. Through such slot it is possible to pass through both steel cable and a high-strength strap. A threaded hole is used to pass through the screw for the main axle, attaching the steel cable or high-strength strap, causing the system to be locked and providing its retracting ability.

The third improvement of the disclosed system is its elastomer profile, shape and mass. The old profile of the rubber band, used in the previous system, had a unidirectional shape. This situation, however, showed many variations when the system was installed in wheel models with the same RIM which presented different shapes in their hubs. The previous system presented the bottom with only one truncation.

In order to minimize such situations, the lower part of the disclosed rubber segment profile has been altered, and two angles have been created, rather than one (as it was before). The disclosed situation became ideal for installing a wheel with a hub that presents protrusion (e.g., carbon steel wheels) and also for flat wheels profiles (light alloy wheels). The composition of the elastomer, in which the disclosed embodiment is made up of, and the new profile allow for the accommodation of the strap in any wheel hub.

Another modification was the way in which this elastomer was vulcanized. Previously, rubber was vulcanized in a straight shape. The rubber took the circular shape only when installed upon the wheel, through fasten of its locking system. The initial straight shape of the rubber band has generated a few inconveniences.

Firstly, there was the difficult adaptation of straight strap in any wheel hub. Second, there was excessive stress exercised by the locking system, which, beyond locking the strap, was causing the strap to be curved in order to take a circular shape of the wheel hub. Third, there were internal stresses in the rubber, considering that rubber was out of its balance shape, being forced to curve in the circular shape.

Therefore, a method to vulcanize the rubber strap already in its semicircular shape has been developed. Its final shape, after vulcanization, is a segment of a predetermined circumference. The semicircular shape of the strap brings significant benefits. First, it is easily suitable for any wheel hub. Secondly, it reduces stress done by the locking system, because much less is required from it in order for the strap to take the circular shape of the wheel hub. Third, there is a drastically reduction of stress inside the rubber because it bears much less deformation.

Nevertheless, it is worthwhile to note that, due to the large amount of weight aggregated to the wheel and tire system of a vehicle, when a protection system is installed, it is necessary to develop a new system that could provide the same product mechanical characteristic, but aggregates less weight to the assembly of the wheel, tire and protection system. An elastomer of greater mechanical capacity has been developed, which has taken away part of the withstanding mass of the upper profile of the system (previously massive). This situation makes the system lighter without altering its mechanical capacities.

The fourth improvement of the disclosed system is its bipartite band and counterweights. The old rubber band profile used in the previous system made it difficult for the system to be molded to the wheel because it was much longer and had quite a big curvature. Its installation on a wheel was difficult, and its locking was impaired. Furthermore, assembled system assembled became very asymmetric.

Due to this situation, it has been developed a system made up of two smaller bands, each one with its own flexible frame and a locking ratchet. The end of one is fixed by the ratchet of another. Each one protects one half of the wheel.

Those two smaller halves bear less curvature upon the wheel installation, greatly improving its modeling to it. This eases its installation and significantly improves its locking on a wheel.

Considering that the system is now constituted by equal halves, it becomes symmetric. That greatly improves its mass distribution, enhancing the system balance. Despite this, the use of lead counterweights inserted at specified points of the band, in order to improve even more the system balance, has been developed.

Those improvements make the disclosed protection system lighter, without altering its mechanical capacities, in addition to rendering the assembly much more practical to handle or maintain compared to prior systems.

We claim:

1. An assembly for use within a tire, said assembly comprising:
two semicircular rubber segments, each having two ends, each segment having a steel cable or strap formed therein, one end of each segment comprising a ratchet for drawing-in the steel cable or strap to pull the ends of the segments together.

2. The assembly according to claim 1, wherein each segment has a trapezoidal profile and a half moon shape.

3. The assembly according to claim 2, wherein each segment has a bottom made up of two blunt planes in different angles and having a plurality of transverse oval holes formed therein.

4. The assemble according to claim 1, wherein each ratchet has a half provided with one holed main axle, having a longitudinal slot that receives the steel cable or the strap, which has one end linked to another half of another ratchet, the axle trespassed by one transverse threaded hole to fix one locking screw of the steel cable or strap.

5. The assembly according to claim 1, wherein balanced counterweights are inserted inside the rubber segments.
